(19) United States
(12) Patent Application Publication
(10) Pub. No.: US 2022/0251824 A1
(43) Pub. Date: Aug. 11, 2022

(54) COUPLING DEVICE FOR THE MODULAR CONSTRUCTION OF STRUCTURES OR OBJECTS

(71) Applicants: Ernest Pacarada, Kelkheim, Taunus (DE); Elvir Pacarada, Kelkheim, Taunus (DE)

(72) Inventor: Elvir Pacarada, Kelkheim, Taunus (DE)

(21) Appl. No.: 17/626,039

(22) PCT Filed: Jun. 22, 2020
(86) PCT No.: PCT/DE2020/200051

§ 371 Date: Jan. 10, 2022

(30) Foreign Application Priority Data
Jul. 10, 2019 (DE) 10 2019 210 175.5

(51) Int. Cl. E04B 1/58

(52) U.S. Cl. CPC E04B 1/5831; E04B 2001/5856

(57) ABSTRACT

A coupling device for the modular construction of structures or objects includes a main body having at least one through-opening or at least one recess and being adapted to be coupled to at least one component of a structure or object. The at least one through-opening or the at least one recess is designed to interact with a coupling means for coupling the at least one component to the main body. The main body is formed as a corner element or edge element of a module of the structure or object.

### BACKGROUND

### Technical Field

The disclosure relates to a coupling device for the modular construction of structures or objects.

### Description of the Related Art

From DE 196 36 294 C1, a coupling device is already known which serves for coupling two components in the form of containers 6. The known coupling device has a main body designed in the shape of a spacer 20, 40, which has a through-opening 28 for a coupling means in the shape of a threaded rod 16. The threaded rod 16 has two screw-on hammer pieces 18, 42 which can be inserted into elongated holes 14 of the containers 6 and engage there with the containers 6. In this manner, a rigid connection of the containers 6 to one another is possible.

In the known coupling device, however, it is problematic that the combined coupling device has a considerable space requirement with its spacer 20, 40 designed for insertion of the threaded rod 16, in such a manner that the containers 6 coupled to one another are spaced relatively far apart in the coupled state, namely according to the dimensions of the spacer 20, 40. Such a large distance between the containers 6 is not desirable, especially in the case of several containers 6 coupled together, since high static requirements of the overall structure consisting of the several containers 6 or components often cannot be met due to the large distances between the containers 6 coupled together. Furthermore, due to the large distances between the containers 6, costly space in warehouses or transport devices, such as ships, is ultimately wasted without use.

### BRIEF SUMMARY AND INITIAL DESCRIPTION

The present disclosure is therefore directed to configuring and developing a coupling device for the modular construction of structures or objects, having a main body which has at least one through-opening or at least one recess and which can be coupled to at least one component of a structure or object, wherein the at least one through-opening or the at least one recess is designed for interacting with a coupling means for coupling the at least one component to the main body. The coupling device is configured in such a manner that a simple and safe construction of structures or objects with structurally simple means is made possible.

In particular, the coupling device is designed and developed in such a manner that the main body is designed as a corner element or edge element of a module of the structure or object.

It has first been recognized that the coupling device is achieved in a surprisingly simple manner by a clever design and arrangement of the main body. The main body forms a component of such a module in a corner region or edge region of the module and does not have, as in the prior art, an additional spacer or intermediate piece to be arranged between two components or modules with the consequence of a correspondingly large distance between the components or modules to be coupled. Consequently, the components or modules to be coupled can be arranged very closely together with the coupling device according to the present disclosure, in a coupled state. This makes it possible to save expensive space to a quite significant degree. In addition, a closely spaced arrangement of components or modules to be coupled is particularly advantageous from a static point of view. In this case, even voluminous building structures or objects constructed in a modular manner satisfy high static requirements and can withstand high weight loads. Due to the interaction of suitable through-openings or recesses with corresponding coupling means, the coupling device according to the present disclosure is suitable for coupling by way of screwing, in such a manner that a time-intensive generation of welded connections between components or building elements to be coupled, as is usually the case in the prior art, can be dispensed with. A dismantling or disassembly of components or objects erected by way of the coupling device according to the disclosure is thus likewise possible when screw connections are used.

Consequently, the coupling device according to the disclosure provides a coupling device with which simple and safe erection of structures or objects is made possible by structurally simple means.

With regard to a particularly stable construction of structures or objects, the coupling device can have a main body made of metal, in particular steel. However, other materials such as plastic or wood can also be used for the production of the main body, depending on the application.

With regard to a particularly safe construction of a structure or object, at least one first connecting element acting substantially between the main body and the at least one component can be assigned to the main body. Such a first connecting element can provide an adaptation with regard to the coupling of the main body and the construction element in the case of differently designed main bodies and components and thus a secure coupling between the main body and the component.

With regard to a particularly stable and secure connection between main bodies arranged next to one another during the construction or in a final state of a structure or object, at least one, preferably flat, second connecting element coupling two or more main bodies can be assigned to the main body. Such a second connecting element can cover several main bodies, for example two, three or four main bodies, in a connection position applied to the main bodies.

To ensure a particularly simple and fast assembly of a structure or object, the at least one first connecting element and/or the at least one second connecting element can each have at least one positioning element for—preferably frictional and/or positive—interaction with at least one corresponding mating element of the main body, preferably formed to be complementary to the at least one positioning element—. For example, by way of such a positioning element and mating element, a person building the structure or the object can carry out particularly fast and secure positioning of the first connecting element and/or of the second connecting element relative to the main body in order to thereby achieve a rapid construction progress.

For this purpose, in a particularly advantageous manner, the at least one positioning element can be designed as an engagement element projecting from the at least one first or second connecting element and the at least one mating element can be designed as a recess in the main body, or alternatively, the at least one positioning element can be designed as a depression in the at least one first or second connecting element and the at least one mating element can be designed as an engagement element projecting from the main body. A particularly simple positioning operation can be provided by inserting the engagement element into the depression or fitting the depression onto the engagement element.

With regard to a particularly secure connection between the main body and the first or second connecting element, the at least one positioning element and/or the at least one mating element can be formed—preferably centrally or in the center—on or in a respective planar region of the main body or of the at least one first or second connecting element. In this case, the planar regions of the main body and of the at least one first or second connecting element in the connected state of the main body and the first or second binding element can lie against each other in a further particularly secure manner. Preferably, the positioning element and/or the mating element can be formed centrally or in the center on the respective planar regions in order to provide an arrangement of positioning element and mating element protected from external influences.

In order to enable positioning security not only with respect to a displacement of positioning element and mating element relative to one another in a displacement plane extending substantially perpendicular to a coupling direction, but also with respect to a rotation about an axis substantially parallel to the coupling direction, the at least one positioning element and/or the at least one mating element can have a substantially rectangular or square shape with preferably beveled side regions or side surfaces. In this regard, the rectangular or square shape contributes to positioning security with respect to rotation, and beveled side regions or side surfaces of the positioning element or the mating element provide easy nesting of the positioning element and the mating element during sliding of the beveled side regions or side surfaces of each of the positioning element and the mating element against one another.

Furthermore, to ensure a particularly simple and fast assembly of a structure or object, the at least one first connecting element may have at least one positioning element for—preferably frictional and/or positive—interaction with at least one corresponding mating element of the at least one structural element, preferably complementary to the at least one positioning element. By way of example of such a positioning element and mating element, a person building the structure or the object can carry out particularly fast and secure positioning of the first connecting element relative to the component in order to thereby achieve a rapid construction progress.

For this purpose, in a particularly advantageous manner, the at least one positioning element can be designed as an insertion or engagement element protruding from the at least one first connecting element and the at least one mating element can be designed as a recess or through-opening in the at least one component, or the at least one positioning element can be designed as a recess or through-opening in the at least one first connecting element and the at least one mating element can be designed as an insertion or engagement element protruding from the at least one component. A particularly simple positioning process can be provided by inserting the insertion or engagement element into the recess or into the through-opening or fitting the recess or the through-opening onto the insertion or engagement element.

With regard to a particularly secure connection between the first connecting element and the component, the at least one positioning element and/or the at least one mating element can be formed, preferably centrally or in the center, on or in a respective planar region of the at least one first connecting element or of the at least one component. In this case, the planar regions of the first connecting element and of the component in the connected state of the first connecting element and the component can lie against one another in a further particularly secure manner. Preferably, the positioning element and/or the mating element can be formed centrally or in the center on the respective planar regions in order to provide an arrangement of positioning element and mating element protected from external influences.

In order to enable positioning security not only with respect to a displacement of positioning element and mating element relative to one another in a displacement plane extending substantially perpendicular to a coupling direction, but also with respect to a rotation about an axis substantially parallel to the coupling direction, the at least one positioning element and/or the at least one mating element can have a substantially rectangular or square shape or cross-sectional shape with preferably beveled side regions or side surfaces. In this regard, the rectangular or square shape or cross-sectional shape contributes to positioning security with respect to rotation, and beveled side regions or side surfaces of the positioning element or the mating element provide easy nesting of the positioning element and the mating element during sliding of the beveled side regions or side surfaces of each of the positioning element and the mating element against one another.

With regard to a particularly secure coupling between the component and the main body and also between a first and/or a second connecting element and the main body, the at least one through-opening or the at least one recess in the main body can have an internal thread for interacting with the coupling means. As a result, a simple coupling of the respective components to one another by a screw connection is possible. Time-consuming welded joints that are very difficult to reverse can be dispensed with. In a particularly advantageous embodiment of a main body, a plurality of or even all through-openings or recesses in the main body can have a suitable internal thread for interacting with a coupling means, for example a screw or a screw bolt or other type of coupling device.

Also with regard to a secure coupling between a first and/or a second connecting element and the main body, the at least one first connecting element and/or the at least one second connecting element can have at least one through-opening for the coupling means.

In order to ensure that the individual components are arranged as close to one another as possible without creating undesirable gaps between the components or unwanted protrusions of coupling means, for example screws or other type of coupling device, the at least one through-opening for the coupling means in the at least one first connecting element and/or in the at least one second connecting element can have a preferably obliquely or conically formed depression or indentation for the coupling means. This enables a countersunk arrangement of a coupling means, for example a screw or other type of coupling device, in a respective component in the coupled state of components or in the assembled state of the structure or object.

In a further advantageous embodiment of the coupling device according to the disclosure, a through-opening for the coupling means can be formed in at least one of the positioning element or mating element of the main body, of the at least one first connecting element and/or of the at least one second connecting element. As a result, a positioning element or mating element cannot only fulfill its positioning task in a space-saving manner but can also have a coupling function.

In a particularly simple embodiment of the coupling device according to the disclosure, the main body can be designed as a cuboid or cube and/or the component can be designed as a square tube or round tube. The concrete design can be based on the respective application.

The coupling device according to the present disclosure can provide a simple, safe and versatile system for modular construction of structures or objects with the main body and the first and/or second connecting element. Structures in the form of any houses, for example, residential buildings, or objects in the form of, for example, furniture can be built.

Various options for advantageously designing and developing the teaching of the present disclosure exist. In this regard, with the aid of the drawings, reference is made, on the one hand, to the subordinate claims and, on the other hand, to the following explanation of preferred exemplary embodiments of the coupling device according to the disclosure. Generally preferred designs and developments of the teaching are also explained in conjunction with the explanation of the preferred exemplary embodiments of the disclosure with reference to the drawings. The drawings show the following:

### BRIEF DESCRIPTION OF THE SEVERAL VIEWS OF THE DRAWINGS

FIG. 1 shows, in two perspective views, an exemplary embodiment of the coupling device according to the present disclosure, one in an assembled state and one in an exploded view, FIG. 2 shows, in two perspective views, the first connecting element of the coupling device from FIG. 1,

FIG. 3 shows, in a perspective view, the second connecting element of the coupling device from FIG. 1,

FIG. 4 shows, in a perspective view, partially as an exploded view, a module of a structure to be built up with a coupling device according to the disclosure,

FIG. 5 shows, in a perspective view, partially as an exploded view, an expanded module of a structure to be built up with the coupling device according to the disclosure,

FIG. 6 shows, in a perspective view, partially as an exploded view, the joining together of several modules of a structure using the coupling device according to the disclosure, and

FIG. 7 depicts, in a perspective view, the modules from FIG. 6 in the assembled state.

### DETAILED DESCRIPTION

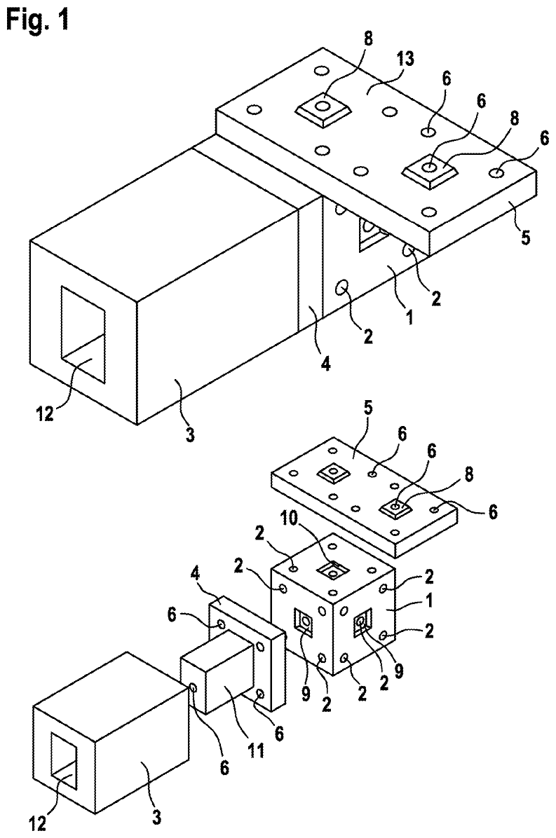

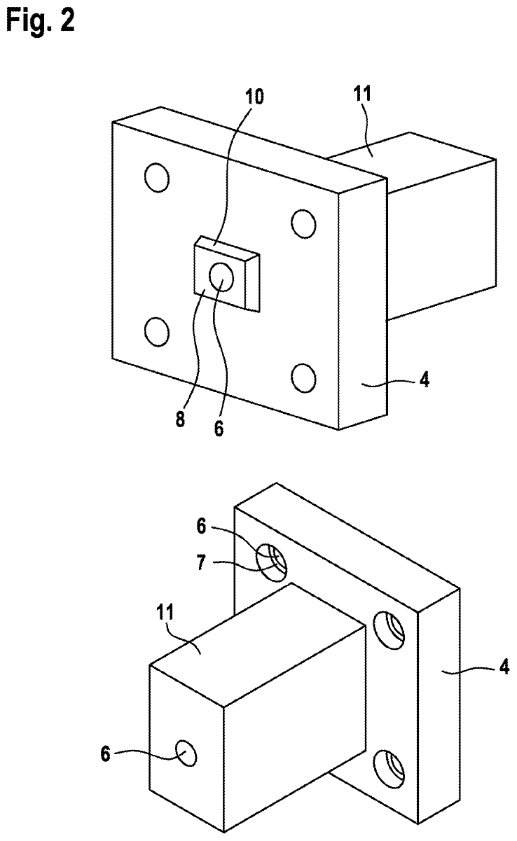

FIG. 1 shows, in two perspective views, an exemplary embodiment of the coupling device according to the present disclosure, wherein in an upper region of FIG. 1, an assembled state of a part of a structure or object to be erected is shown, and in the lower region of FIG. 1, the corresponding components from the upper region are shown in an exploded view. In this case, a coupling device for the modular construction of structures or objects is shown which has a main body 1 which has a plurality of through-openings 2 and which can be coupled to a component 3 of the structure. The through-opening 2 is designed for interacting with a coupling means, for example a screw or other type of coupling device, for coupling the component 3 to the main body 1. In this case, the main body 1 and the component 3 are coupled to one another via a first connecting element 4 made of metal, preferably steel. Furthermore, in FIG. 1, a planar second connecting element 5 made of metal, preferably steel, is also shown, which serves to couple two or more main bodies 1 to one another.

With regard to a particularly simple and secure coupling of several components 3 or modules of a structure or object, the main body 1 is designed as a corner element or edge element of such a module.

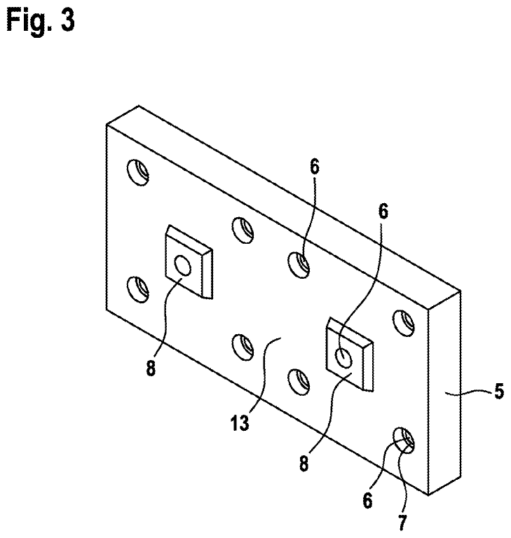

The first connecting element 4 is also shown in two enlarged perspective views of different sides from different sides in FIG. 2. The second connecting element 5 is also shown in an enlarged perspective view in FIG. 3.

Both the first connecting element 4 and the second connecting element 5 have through-openings 6 for inserting or passing through of a coupling means, which have a depression 7 for countersinking or sinking the coupling means, which recess can be formed obliquely or conically.

Furthermore, the first connecting element 4 has a positioning element 8 for form-fitting interaction with a mating element 9 of the main body 1 that is complementary to the positioning element 8. In this case, the positioning element 8 is formed as an engagement element protruding from the first connecting element 4, and the mating element 9 as a depression in the main body 1. Both the positioning element 8 and the mating element 9 are formed centrally in each case in a planar region of the first connecting element 4 and of the main body 1. A through-opening 6, 2 for a coupling means is formed both in the positioning element 8 and in the mating element 9.

The positioning element 8 and the mating element 9 each have a substantially square shape with beveled side surfaces 10, wherein the square shape forms a safeguard against a mutual rotation of the first connecting element 4 and the main body 1 in the assembled state. This ensures the positioning security with respect to rotation. The beveled side surfaces 10 facilitate the insertion of the positioning element 8 into the mating element 9 and thus the positioning of the first connecting element 4 relative to the main body 1 during assembly.

Furthermore, the first connecting element 4 has a positioning element 11 for form-fitting interaction with a mating element 12 of the main body 3 that is complementary to the positioning element 11. The positioning element 11 is designed as an insertion or engagement element protruding from the first connecting element 4 and the mating element 12 as a through-opening in the component 3. Both the positioning element 11 and the mating element 12 have a rectangular cross-sectional shape in order to ensure a safeguard against an undesired rotation of the first connecting element 4 relative to the component 3 when the insertion or engagement element is inserted into the through-opening. Both the positioning element 11 and the mating element 12 are formed centrally in each case in a planar region of the first connecting element 4 and of the component 3.

The second connecting element 5 has a rectangular shape in order to cover two square outer surfaces of two main bodies 1 and thus provide a coupling between the two main bodies 1. The main body 1 is thus designed as a “two-part element.” In order to cover and couple three or four main bodies 1, the second connecting element 5 can be designed as a “three-part element” or “four-part element.” A “four-part element” could have a substantially square shape.

In the present exemplary embodiment, the main body 1 is formed as a cube. The planar region of the first connecting element 4 has a square basic shape. The component 3 has the configuration of a square tube with a rectangular internal through-opening. However, other configurations of the main body 1, the connecting elements 4 and 5 and the component 3 are also possible.

The second connecting element 5 can have positioning elements 8 not only on the front side 13 shown in FIG. 3, but also on the rear side (not shown in FIG. 3) or only on this rear side. In a particularly versatile and advantageous manner, the positioning elements 8 are formed both on the front side 13 and on the rear side. This particularly advantageous design can be inferred implicitly from FIG. 1, since there the rear side of the second connecting element 5 comes into contact with the main body 1.

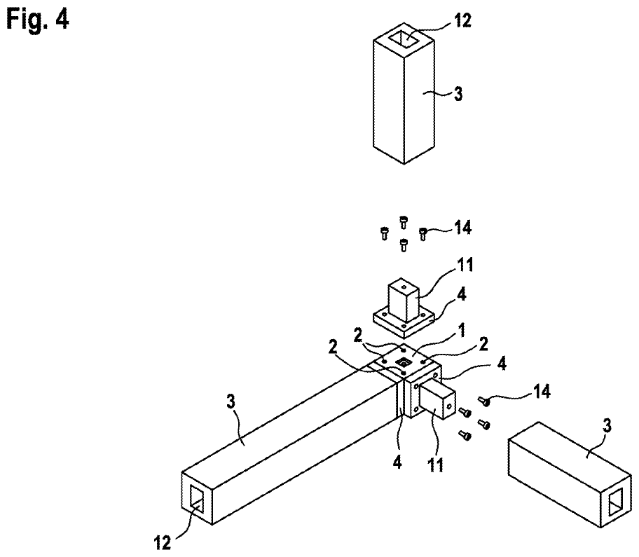

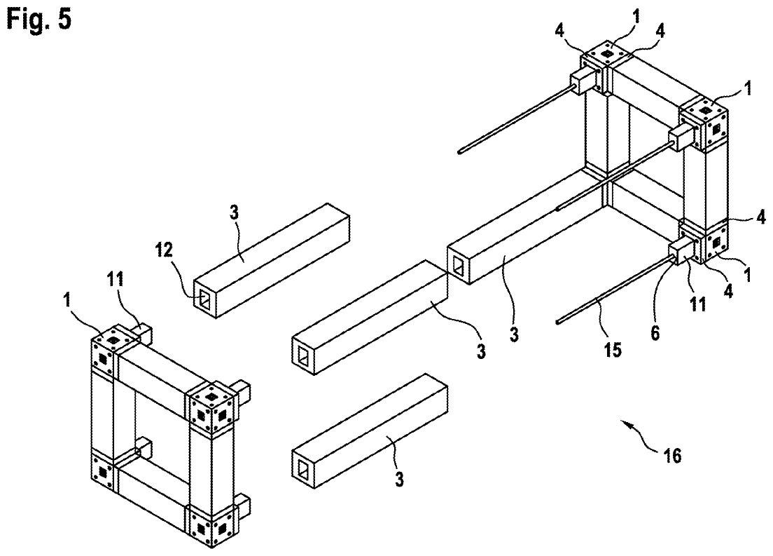

FIGS. 4 and 5 show the construction of a module 16 of a structure by way of the coupling device according to the present disclosure. In this case, according to FIG. 4, a respective component 3 is coupled to three outer surfaces of the main body 1 by way of a first connecting element 4. To fix the first connecting element 4 to the main body 1 in this example, coupling means in the shape of bolts 14 are used, wherein suitable internal threads are formed in corresponding through-openings 2 of the main body 1 for screwing in the screws 14. The screws 14 have heads which are countersunk in recesses 7 of the through-openings 6 of the first connecting elements 4 in the assembled state of the module 16.

In FIG. 5, coupling elements designed as rods 15 are shown, which are insertable into through-openings 6 of the positioning elements 11 of the first connecting elements 4 and extend in the assembled state of the module 16 through the components 3 in order to enable a secure coupling of the components. In this case, the rods 15 or coupling elements can have external threads for engagement with internal threads in through-openings 2 of the main body 1. In the exemplary embodiment shown here, in the assembled state of the components, a substantially cuboid module 16 results, wherein the main elements 1 are formed as corner elements of the module 16 and thus form an integral component of the module 16.

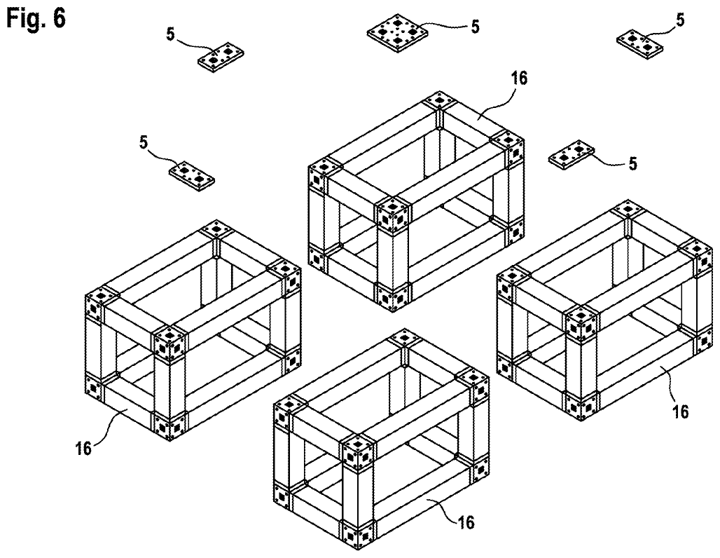

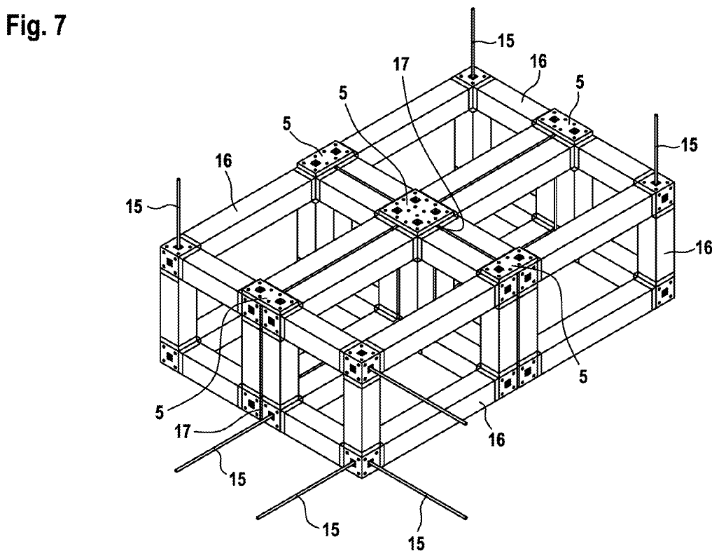

FIGS. 6 and 7 show the construction of an object composed of four modules 16, wherein the four modules 16 each correspond to the module 16 shown in FIG. 5. With regard to the assembly of the modules 16, reference may therefore be made to the description relating to FIGS. 4 and 5 in this regard. In accordance with FIGS. 6 and 7, the four modules 16 are joined together to form a cuboid, wherein second connecting elements 5 are used for coupling main bodies 1 arranged next to one another. In the middle of an upper outer surface of the cuboid, a second connecting element 5 designed as a “four-part element” is used for connecting and covering four main bodies 1 arranged next to one another. The four main bodies 1 are arranged next to one another in a suitable manner for forming a square shape. With regard to a particularly high stability of the cuboid produced from the four modules 16, a second connecting element 5 can be attached at any point at which two or more main bodies 1 are arranged next to one another. In the exemplary embodiment shown here, this could additionally take place on the side surfaces and/or on the bottom side of the cuboid.

In order to further increase the stability and improvement of the statics of the cuboid or object or structure produced, a second connecting element 5 can also be arranged in clearances 17 between main bodies 1 arranged next to one another. In this case, a second connecting element 5 designed as a “two-part element” can be arranged, for example, in the clearance 17 below the “four-part element.” Also, “half” “two-part elements” can be arranged in clearances 17, see the clearance 17 designated in the lower region of FIG. 7.

Furthermore, rods 15 as coupling elements on some main bodies 1 are shown by way of example in FIG. 7, for example to couple further modules 16 or further cuboids composed, for example, of four modules 16 to different sides of the cuboid. For example, two cuboids of the type shown in FIG. 7 can be arranged one above the other and can be coupled with regard to a secure connection by way of the rods 15. Of course, rods 15 can be arranged independently in a plurality of or in all main bodies 1, which are required or useful for secure coupling, for example, of further modules 16 or cuboids. On the basis of the modules 16 shown here, it is possible to implement very different structures, such as high-rise buildings or objects.

With the coupling device according to the present disclosure, it is possible to erect virtually any large structures such as buildings or houses in a simple, secure and quick manner in a modular design.

With regard to further advantageous designs of the coupling device according to the disclosure, reference is made to the general part of the description and to the appended claims in order to avoid repetitions.

Finally, it is expressly pointed out that the above-described exemplary embodiments serve only to explain the claimed teaching, but do not restrict it to the exemplary embodiments.

### LIST OF REFERENCE SIGNS

1 main body
2 through-opening
3 component
4 first connecting element
5 second connecting element
6 through-opening
7 depression
8 positioning element
9 mating element
10 side surface
11 positioning element
12 mating element
13 front side
14 screw
15 rod
16 module
17 clearance

The various embodiments described above can be combined to provide further embodiments. Aspects of the embodiments can be modified, if necessary, to provide yet further embodiments. These and other changes can be made to the embodiments in light of the above detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A coupling device for the modular construction of structures or objects, comprising a main body which has at least one through-opening or at least one recess and which can be coupled to at least one component of a structure or object, wherein the at least one through-opening or the at least one recess interacts with a coupling means for coupling the at least one component to the main body,
wherein the main body is a corner element or edge element of a module of the structure or object.

2. The coupling device according to claim 1, wherein at least one first connecting element acting substantially between the main body and the at least one component is assigned to the main body.

3. The coupling device according to claim 2, wherein at least one second connecting element coupling two or more main bodies is assigned to the main body.

4. The coupling device according to claim 3, wherein the at least one first connecting element and/or the at least one second connecting element (5) each have at least one positioning element for interacting with at least one corresponding mating element of the main body, complementary to the at least one positioning element.

5. The coupling device according to claim 4, wherein the at least one positioning element is an engagement element projecting from the at least one first or second connecting element and the at least one mating element is a recess in the main body, or
wherein the at least one positioning element is a recess in the at least one first or second connecting element and the at least one mating element is an engagement element projecting from the main body.

6. The coupling device according to claim 4, wherein the at least one positioning element and/or the at least one mating element are or is formed centrally or in the center on or in a respective planar region of the main body or of the at least one first or second connecting element.

7. The coupling device according to claim 4, wherein the at least one positioning element and/or the at least one mating element have a substantially rectangular or square shape.

8. The coupling device according to claim 2, wherein the at least one first connecting element has at least one positioning element for interacting with at least one corresponding mating element of the at least one component, complementary to the at least one positioning element.

9. The coupling device according to claim 8, wherein the at least one positioning element is formed as an insertion or engagement element projecting from the at least one first connecting element and the at least one mating element is formed as a recess or through-hole in the at least one component, or
wherein the at least one positioning element is formed as a recess or through-hole in the at least one first connecting element and the at least one mating element is formed as an insertion or engagement element projecting from the at least one component.

10. The coupling device according to claim 8, wherein the at least one positioning element and/or the at least one mating element are or is formed centrally or in the center on or in a respective planar region of the at least one first connecting element or of the at least one structural element.

11. The coupling device according to claim 8, wherein the at least one positioning element and/or the at least one mating element has or have a substantially rectangular or square shape or cross-sectional shape.

12. The coupling device according to claim 1, wherein the at least one through-opening or the at least one recess in the main body has an internal thread for interacting with the coupling means.

13. The coupling device according to claim 3, wherein the at least one first connecting element and/or the at least one second connecting element have or has at least one through-opening for the coupling means.

14. The coupling device according to claim 13, wherein the at least one through-opening for the coupling means in the at least one first connecting element and/or in the at least one second connecting element have or has an oblique or conical depression or indentation for the coupling means.

15. The coupling device according to claim 4, wherein in at least one positioning element or mating element of the main body, the at least one first connecting element, and/or the at least one second connecting element, a through-opening for the coupling means is formed.
